(19) United States
(12) Patent Application Publication
(10) Pub. No.: US 2004/0084496 A1
(43) Pub. Date: May 6, 2004

(54) Adhesive-tape support device of an adhesive-tape holder

(76) Inventor: Hsiu-Man Yu Chen, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/285,439

(22) Filed: Nov. 1, 2002

(51) Int. Cl. B26F 3/02

(52) U.S. Cl. 225/25; 225/34

(57) ABSTRACT

An adhesive-tape support device of an adhesive-tape holder includes an adhesive-tape holder provided at one end with plural rotatable wheels preset in number for tape rolls to be mounted thereon and fitted at the other end with a blade base. Plural horizontal support rods preset in number are provided between the blade base and the rotatable wheels, respectively having one end secured at a proper interval on an inner side of the adhesive-tape holder and the other end dangling without support. The support rods are of different lengths and positioned at different heights for different-sized adhesive tapes to be fitted and supported thereon, needless to take much space for storing the adhesive tapes, able to match with different-sized adhesive tapes and convenient in use.

### BACKGROUND OF THE INVENTION

This invention relates to the adhesive-tape support device of an adhesive-tape holder, particularly to one able to be fitted thereon with different-sized adhesive tapes for use at the same time.

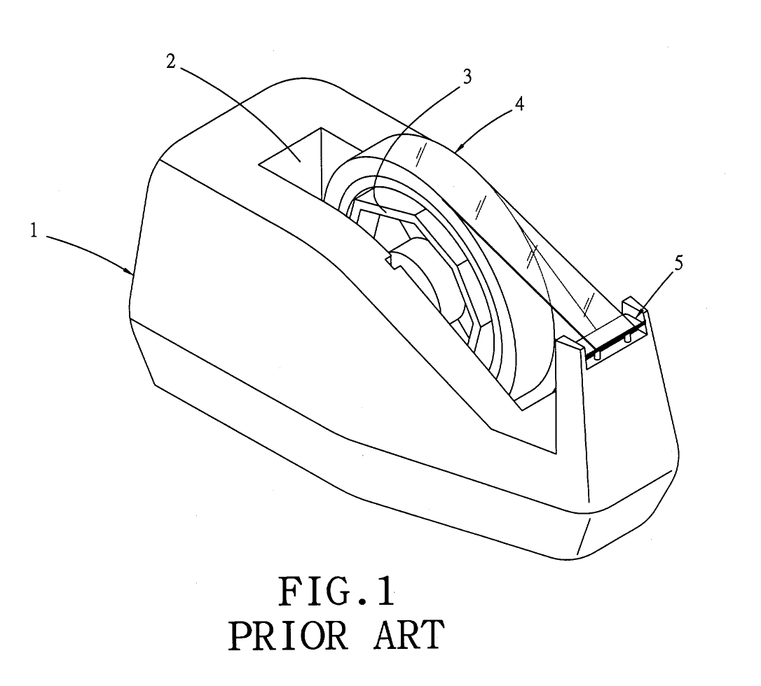

A conventional adhesive-tape holder 1, as shown in FIG. 1, has a rotating wheel 3 disposed in its hollow interior 2 for fitting a tape roll 4 thereon and a blade 5 provided at the front end for cutting an adhesive tape, convenient in use.

However, the conventional adhesive-tape holder 1 is applicable to only one adhesive tape 4 of a single width, therefore different specifications of adhesive-tape holders 1 for installing different-sized adhesive tapes have to be produced in order to meet a user's requirements, thus increasing producing cost, taking too much space for storing the products and resulting in much inconvenience to a user.

### SUMMARY OF THE INVENTION

The objective of the invention is to offer an adhesive-tape support device of an adhesive-tape holder able to receive more than two tape rolls of different widths for use at the same time, lowering producing cost, meeting a user's requirements and convenient in use.

### BRIEF DESCRIPTION OF DRAWIINGS

This invention will be better understood by referring to the accompanying drawings, wherein:

FIG. 1 is a perspective view of a conventional adhesive-tape holder:

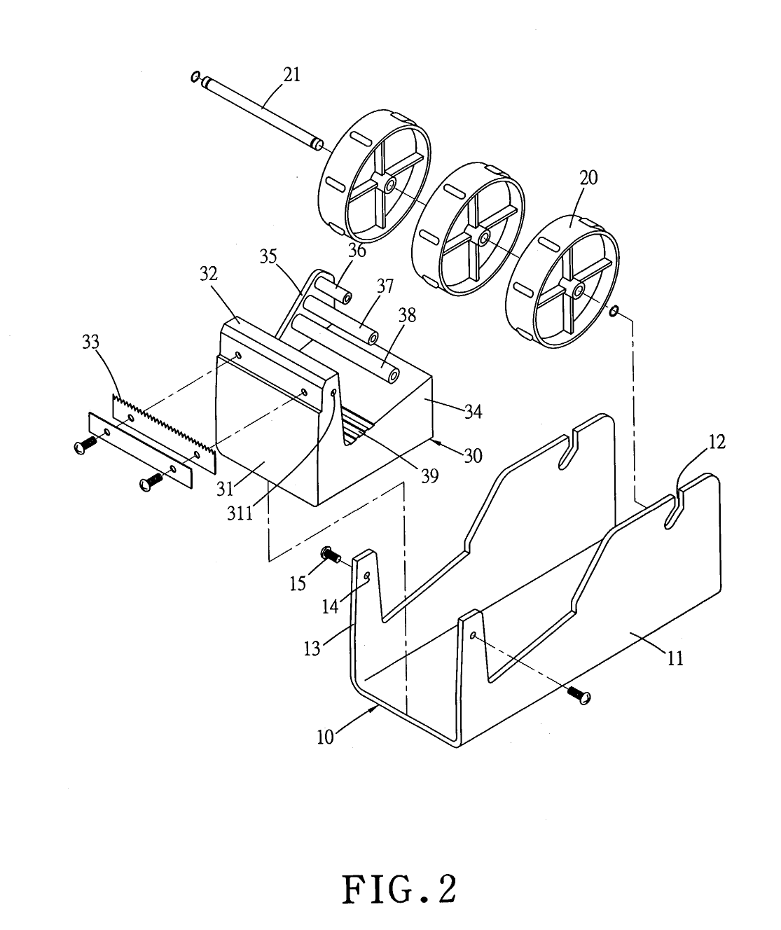

FIG. 2 is an exploded perspective view of an adhesive-tape support device of an adhesive-tape holder in the present invention:

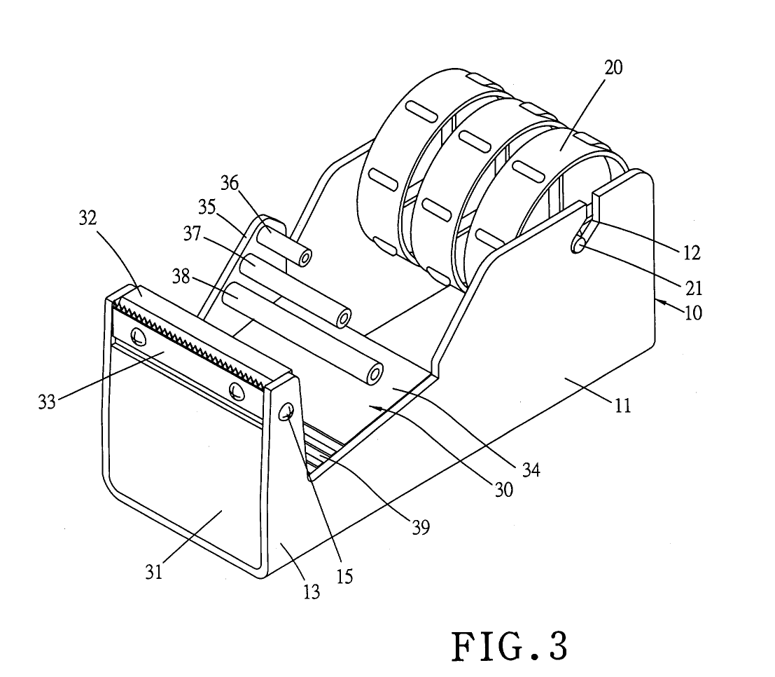

FIG. 3 is a perspective view of the adhesive-tape support device of the adhesive-tape holder in the present invention:

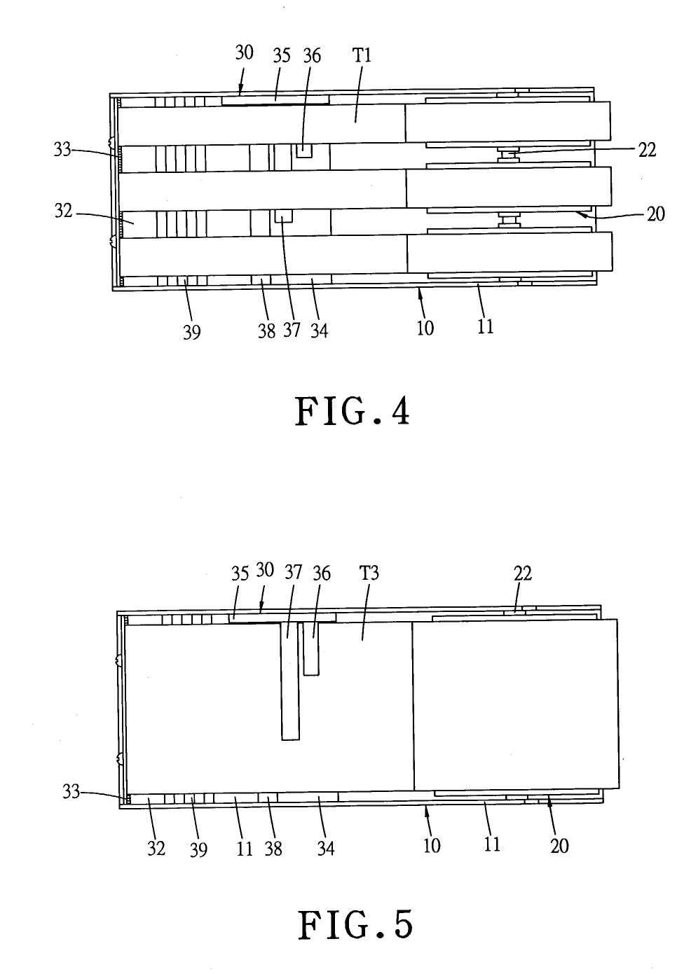

FIG. 4 is an upper view of the adhesive-tape support device in a first using condition in the present invention:

FIG. 5 is an upper view of the adhesive-tape support device in a second using condition in the present invention:

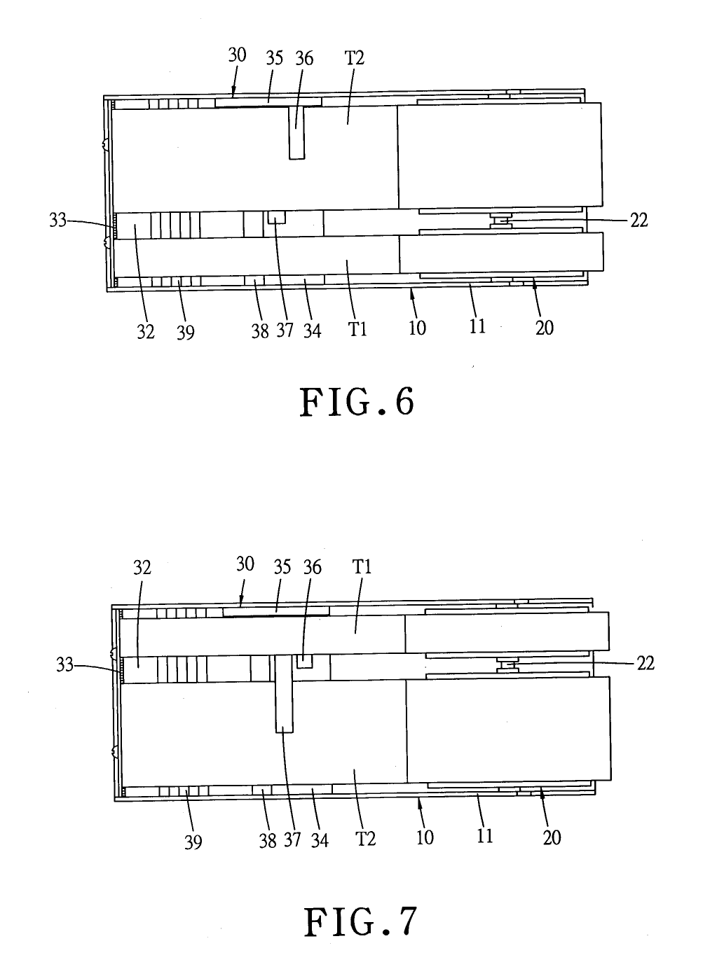

FIG. 6 is an upper view of the adhesive-tape support device in a third using condition in the present invention: and

FIG. 7 is an upper view of the adhesive-tape support device in a fourth using condition in the present invention.

### DETAILED DESCRIPTION OF THE PREFERRED EMBODIMENT

A preferred embodiment of an adhesive-tape support device of an adhesive-tape holder in the present invention, as shown in FIGS. 2 and 3, includes an adhesive-tape holder 10, three rotating wheels 20 and a fixing base 30.

The adhesive-tape holder 10 is formed with two perpendicular side plates 11 respectively extending upward at the opposite sides and having a curved notch 12 at a rear upper side. The adhesive-tape holder 10 is further formed at the front end with two support arms 13 extending upward at the front side and respectively having a round hole 14 near the upper end for a bolt 15 to be inserted therethrough.

The three rotatable wheels 20 are axially pivoted together by a shaft 21 having its opposite ends respectively fitted in the curved notches 12 of the side plates 11 of the adhesive-tape holder 10. The three rotating wheels 20 are able to rotate independently not to involve one another at all.

The fixing base 30 is formed integral at the front side with a blade base 31 having a threaded hole 311 in respectively the opposite upper side edges. The fixing base 30 is firmly fixed between the two support arms 13 of the adhesive-tape holder 10 by the two bolts 15 respectively inserted through both the round holes 14 of the two support arms 13 and the two threaded holes 311 of the blade base 31. Further, the fixing base 30 is provided with an adhering flat surface 32 on the upper side for adhesive tapes to be adhered thereon temporarily. The blade base 31 is provided with a cutting device 33 at its front upper end for cutting an adhesive tape. Besides, a sloped-up portion 34 is formed to extend from the lower portion of the blade base 31, and a side plate 35 extending upward perpendicularly from one side of the sloped-up portion 34.

The side plate 35 is secured on its inner wall with three horizontal support rods 36, 37 and 38 of different lengths, with the outer ends of the three support rods 36, 37 and 38 respectively dangling without support. Besides, the three support rods 36, 37 and 38 of different lengths are equidistantly positioned at different heights, with their respective length conforming to respective width of three different-sized adhesive tapes on market, and the longest support rod 38 is positioned at the lowermost point on the side plate 35. In addition, a corrugated surface 39 is formed between the blade base 31 and the slope rising portion 34 to reinforce the whole strength of the fixing base 30.

For the present, there are three specifications of tape rolls: a narrow adhesive tape (T1), a medium-sized adhesive tape (T2) and a wide adhesive tape (T3).

When the narrow adhesive tape (T I) is to be used only, three same-sized tape rolls (T1) are respectively mounted on the three rotatable wheels 20 to enable a user to employ any one of them as desired and then respectively fitted around the three support rods 36, 37 and 38, which are equidistantly located at different heights, and adhered to the adhering surface 32 to let a user use any of the adhesive tapes with easiness, as shown in FIG. 4.

In case the wide adhesive tape (T3) is to be used, three same-sized tape rolls are mounted on the three rotatable wheels 20 and then fitted around the support rod 38 and adhered to the adhering surface 32 for use afterward.

In case the narrow and the medium-sized adhesive tape (T1) and (T2) are to be used at the same time, they are respectively mounted on the rotating wheels 20 and then orderly fitted around the support rods 38, 37, as shown in FIG. 6, or around the support rods 36, 38 and adhered temporarily on the adhering surface 32 to be employed, as shown in FIG. 7. Thus, the different-sized adhesive tapes (T1) and (T2) are separately fitted around two of the support rods 36, 37 and 38 of different lengths and at different heights so as to let a user use the adhesive tapes conveniently and quickly.

To sum up, the adhesive-tape holder 10 in the present invention is applicable to any of all of the adhesive tape (T 1), (T2) and (T3) of different widths, needless to prepare several adhesive-tape holders 10 of different specifications at the same time for matching with different-sized adhesive tapes.

While the preferred embodiment of the invention has been described above, it will be recognized and understood that various modifications may be made therein and the appended claims are intended to cover all such modifications that may fall within the spirit and scope of the invention.

I claim:

1. An adhesive-tape support device of an adhesive-tape holder comprising an adhesive-tape holder, said adhesive-tape holder provided with plural rotatable wheels preset in number at one end for a plurality of tape rolls to be mounted thereon, said adhesive-tape holder provided with a blade base at the other end: and,
Characterized by plural support rods preset in number positioned horizontally between said blade base and said rotatable wheels, said support rods respectively having one end secured on one side of said adhesive-tape holder, said support rods respectively having the other end dangling without support, said support rods being of different lengths.

2. The adhesive-tape support device of an adhesive-tape holder as claimed in claim 1, wherein said adhesive-tape holder is provided with three of said support rods respectively positioned equidistantly at different heights and the longest of said support rods is located at the lowermost point.

3. The adhesive-tape support device of an adhesive-tape holder as claimed in claim 1, wherein said support rods are fixed on the inner wall of a side plate of a fixing base which has said blade base formed integral at the upper front end.

4. The adhesive-tape support device of an adhesive-tape holder as claimed in claim 1, where an adhering surface is provided at the upper side of said fixing base for adhesive tapes to be adhered thereon temporarily, a cutting device is provided at the upper front end of said blade base for cutting adhesive tapes, and a sloped-up portion is formed to extend rearward from said blade base.
